(19) United States
(12) Patent Application Publication
(10) Pub. No.: US 2026/0017810 A1
(43) Pub. Date: Jan. 15, 2026

(54) ALIGNMENT SYSTEM FOR SPECIMEN INSPECTION

(71) Applicant: Nanotronics Imaging, Inc., Cuyahoga Falls, OH (US)

(72) Inventors: Anuj Doshi, Long Island City, NY (US); Joanna Lee, Brooklyn, NY (US); John B. Putnam, Celebration, FL (US)

(73) Assignee: Nanotronics Imaging, Inc., Cuyahoga Falls, OH (US)

(21) Appl. No.: 18/770,304

(22) Filed: Jul. 11, 2024

(51) Int. Cl. G06T 7/33; G06T 7/00; G06V 10/25

(52) U.S. Cl. CPC G06T 7/337; G06T 7/0006; G06T 7/001; G06T 2207/20081; G06T 2207/20104; G06T 2207/20224; G06T 2207/30148; G06V 10/25

(57) ABSTRACT

Systems and methods of analyzing aligning a golden template with a scanned image of specimen under manufacture are disclosed herein. A computing system generates a golden template for a patterned specimen design by forming a single coherent image from a first plurality of scanned images of a plurality of specimens manufactured according to the patterned specimen design. The computing system identifies a plurality of regions of interest in the patterned specimen design that is present across a second plurality of scanned images of the plurality of specimens manufactured according to the patterned specimen design. The computing system receives a new scanned image of a new specimen manufactured in accordance with the patterned specimen design. The computing system aligns the golden template with the new scanned image of the new specimen by performing a pixel-by-pixel analysis in the plurality of regions of interest only.

### FIELD OF DISCLOSURE

The present disclosure generally relates to the field of patterned device inspection, and more specifically, to methods and systems that utilize machine learning techniques for aligning a golden template with an image of a specimen for efficient defect detection.

### BACKGROUND

Inspecting materials for uniformity and detection of anomalies is important in disciplines ranging from manufacturing to science to biology. Inspection often employs microscopy inspection systems to examine and measure specimens. Specimens as used herein refer to an object of examination (e.g., wafer, substrate, etc.) and artifact refers to a specimen, portion of a specimen, features, abnormalities and/or defects in the specimen. For example, artifacts can be electron-based or electronic devices such as transistors, resistors, capacitors, integrated circuits, microchips, etc., biological abnormalities, such as cancer cells, or defects in a bulk material such as cracks, scratches, chips, etc.

### SUMMARY

In some embodiments, a method of analyzing aligning a golden template with a scanned image of specimen under manufacture is disclosed herein. A computing system generates a golden template for a patterned specimen design by forming a single coherent image from a first plurality of scanned images of a plurality of specimens manufactured according to the patterned specimen design. The computing system identifies a plurality of regions of interest in the patterned specimen design that is present across a second plurality of scanned images of the plurality of specimens manufactured according to the patterned specimen design. The computing system receives a new scanned image of a new specimen manufactured in accordance with the patterned specimen design. The computing system aligns the golden template with the new scanned image of the new specimen by performing a pixel-by-pixel analysis in the plurality of regions of interest only.

In some embodiments, a non-transitory computer readable medium is disclosed herein. The non-transitory computer readable medium includes one or more sequences of instructions, which, when executed by a processor, causes a computing system to perform operations. The operations include generating, by the computing system, a golden template for a patterned specimen design by forming a single coherent image from a plurality of scanned images of a plurality of specimens manufactured according to the patterned specimen design. The operations further include identifying, by the computing system, a plurality of regions of interest in the patterned specimen design that is present across a second plurality of scanned images of the plurality of specimens manufactured according to the patterned specimen design. The operations further include receiving, by the computing system, a new scanned image of a new specimen manufactured in accordance with the patterned specimen design. The operations further include aligning, by the computing system, the golden template with the new scanned image of the new specimen by performing a pixel-by-pixel analysis in the plurality of regions of interest only.

In some embodiments, a system is disclosed herein. The system includes a processor and a memory. The memory has programming instructions stored thereon, which, when executed by the processor, causes the system to perform operations. The operations include generating a golden template for a patterned specimen design by forming a single coherent image from a plurality of scanned images of a plurality of specimens manufactured according to the patterned specimen design. The operations further include identifying a plurality of regions of interest in the patterned specimen design that is present across a second plurality of scanned images of the plurality of specimens manufactured according to the patterned specimen design. The operations further include receiving a new scanned image of a new specimen manufactured in accordance with the patterned specimen design. The operations further include aligning the golden template with the new scanned image of the new specimen by performing a pixel-by-pixel analysis in the plurality of regions of interest only.

### BRIEF DESCRIPTION OF FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 is a block diagram illustrating a workflow for pre-processing images for golden template creation and identification of best regions in a patterned specimen design for alignment, according to example embodiments.

FIG. 3 is a block diagram illustrating a workflow for detecting defects on a specimen, according to example embodiments.

FIG. 4 is a flow diagram illustrating a method of creating a golden template and identifying one or more regions in a patterned specimen design for alignment, according to example embodiments.

FIG. 5 is a flow diagram illustrating a method of identifying one or more regions of interest for template matching, according to example embodiments.

FIG. 6 is a flow diagram illustrating a method of analyzing an image of a specimen for artifacts, according to example embodiments.

FIG. 7A is a block diagram illustrating a computing device, according to example embodiments of the present disclosure.

FIG. 7B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

In the field of patterned specimen inspection, such as but not limited to semiconductor substrate inspection, a common practice involves the use of a golden template. This golden template is typically generated by combining a plurality of images of patterned specimens, representing an ideal or standard version of a patterned specimen design. The golden template serves as a reference for comparison against new images of patterned specimens that have been manufactured, allowing for the detection of any defects or errors in the substrate.

A pivotal step in this process is the alignment of the new image of the patterned specimen with the golden template. This alignment is typically achieved through a pixel-by-pixel comparison between the new image and the golden template. This process can be particularly time-consuming and complex, especially when dealing with high-resolution images. For instance, when a 4k image resolution is used, the system is tasked with comparing over eight million pixels per image.

One or more techniques disclosed herein improve upon conventional methods by utilizing machine learning techniques to identify constant regions on the patterned specimen design across each image, thereby facilitating a more efficient alignment process. In some embodiments, the method may involve training an artificial intelligence model to analyze multiple images of multiple patterned specimens for a given design and identify distinct regions. These distinct regions may then be used for alignment, potentially making the process three times faster than traditional methods. In some cases, the method may employ the intersection over union algorithm, a common metric in the field of computer vision, to identify these distinct regions.

In addition to or in lieu of the machine learning approach, in some embodiments, an operator may select one or more regions to create a segmentation mask. Once the regions of interest are aligned with the golden template, the system may be capable of identifying and possibly classifying defects based on the comparison.

The methods and systems described herein may offer several technical benefits. For example, by focusing on distinct regions rather than individual pixels, the alignment process may be expedited, potentially leading to increased efficiency in defect detection. Furthermore, the use of machine learning techniques may allow for a more accurate identification of distinct regions, thereby enhancing the precision of the alignment process. These technical effects may address the technical problems associated with the time-consuming and complex nature of traditional alignment methods.

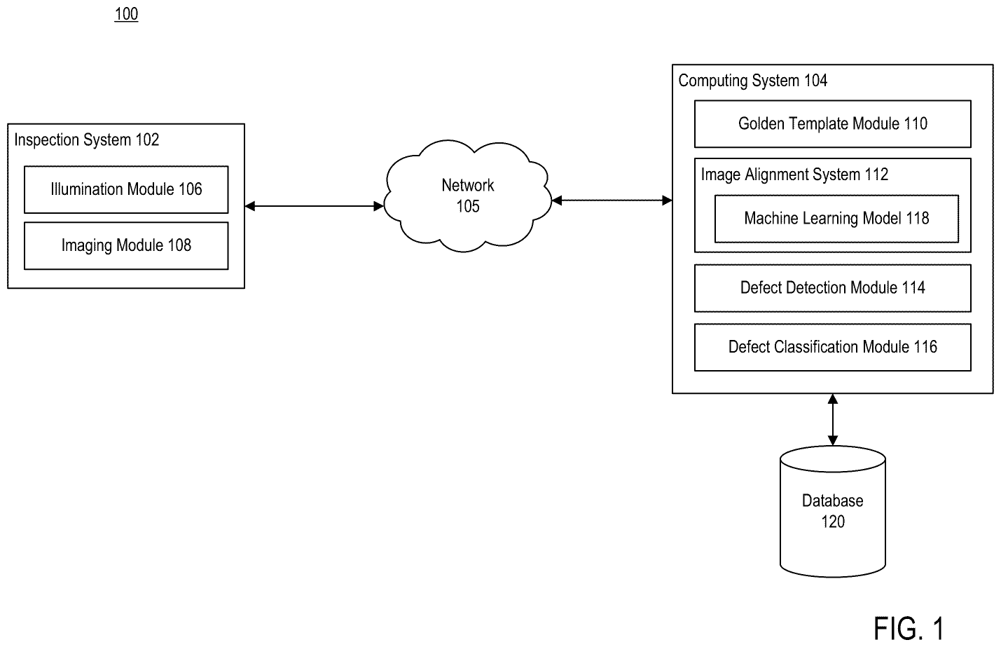

FIG. 1 is a block diagram illustrating a computing environment 100, according to example embodiments. In some embodiments, computing environment 100 may be representative of an environment for inspecting patterned specimens and detecting defects thereon. Computing environment 100 may include an inspection system 102 and a computing system 104 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

Inspection system 102 may be configured to image and/or inspect patterned specimens, such as, but not limited to, semiconductor or integrated circuit devices formed on substrates. Inspection system 102 may include an illumination module 106 and imaging module 108. Illumination module 106 may be configured to illuminate a specimen with one or more light sources. In some embodiments, one or more light sources may be configured to direct oblique light or direct light to the surface of the specimen. Imaging module 108 may be configured to capture images of the specimens. In some embodiments, imaging module 108 may be configured to capture images of light reflected from the specimen. In some embodiments, illumination module 106 may move the one or more light sources to different positions located circumferentially around the object, with images taken at each position. In some embodiments, inspection system 102 may provide the images to computing system 104 for processing.

Computing system 104 may be configured to analyze the images captured by inspection system 102 and identify any artifacts that may be present on the specimen. Computing system 104 may include golden template module 110, image alignment system 112, defect detection module 114, and defect classification module 116.

Each of golden template module 110, image alignment system 112, defect detection module 114, and defect classification module 116 may be comprised of one or more software modules. The one or more software modules are collections of code or instructions stored on a media (e.g., memory of computing system 104) that represent a series of machine instructions (e.g., program code) that implements one or more algorithmic steps. Such machine instructions may be the actual computer code the processor of computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Golden template module 110 may be configured to create a golden template for a target patterned specimen design. For example, golden template module 110 may be configured to generate a golden template by receiving a plurality of scanned images of specimens fabricated according to the patterned specimen design. Golden template module 110 may generate a golden template for the patterned specimen design by aggregating each of the plurality of scanned images into a single image. The golden template will then act as the standard or template against which each new scanned image is compared for purposes of image alignment and defect detection.

Image alignment system 112 may be configured to align the golden template of a patterned specimen design to images of specimens received from inspection system 102. In some embodiments, a golden template may refer to a standard or benchmark design against which other specimens are compared for the purpose of identifying artifacts contained thereon. In order to compare images of specimens to the golden template, image alignment system 112 may first align an orientation of the golden template with an orientation of the specimen in the received image.

As indicated above, the conventional process of aligning the golden template to images of is highly involved and requires allocation of computing resources to perform a pixel-by-pixel comparison between the image of the specimen and the golden template to determine whether the orientation of the specimen in the image is aligned with the orientation of the specimen in the golden template. Once an offset between the image of the specimen and the golden template is determined, image alignment system 112 may adjust the golden template based on the determined offset.

To improve the efficiency of this process, rather than employ a pixel-by-pixel comparison for the purpose of aligning the image to the golden template, image alignment system 112 may be configured to compare known distinct regions of the patterned specimen design between the captured images and the golden template.

In some embodiments, image alignment system 112 may employ a machine learning model 118 to identify distinct regions in the patterned specimen design for comparison. In some embodiments, machine learning model 118 may be representative of a semantic segmentation model. Machine learning model 118 may be configured to create segmentation masks based on a plurality of images of a specimen for a given patterned specimen design. Through the segmentation masks, machine learning model 118 may identify a plurality of regions or boxes in the plurality of images that are significantly distinct and common across the plurality of images. For example, machine learning model 118 may implement an intersection over union analysis to determine which regions or boxes are present in each image. Those regions or boxes that are present in each image may be deemed significantly distinct for purposes of image alignment. Thus, when image alignment system 112 aligns a new image of the specimen for the patterned specimen design to the golden template, image alignment system 112 may only need to compare pixels within the identified regions or boxes, significantly reducing the computational load for aligning images. Such a process may reduce the 4k pixel by 4k pixel comparison to as little as a 100 pixel by 100 pixel comparison.

In some embodiments, rather than employ machine learning model 118 to identify significantly distinct regions or boxes, an operator may instruct image alignment system 112 on those regions or boxes that are significantly distinct in the patterned specimen design. Image alignment system 112 may then use these regions or boxes in a similar fashion to align scanned images of the specimen to the golden template. In some embodiments, rather than the manual process being perform in lieu of machine learning model 118, such process may be used to supplement machine learning model 118. For example, in a case where an operator may notice that machine learning model 118 has not identified a significantly distinct region of interest, the operator may instruct image alignment system 112 accordingly.

Once the images are aligned to the golden template, defect detection module 114 may identify defects. In some embodiments, defect detection module 114 may identify artifacts by subtracting the golden template from each image.

Defect classification module 116 may be configured to classify each of the detected artifacts. For example, defect classification module 116 may employ a deep learning model that may create embeddings from the identified defects. The deep learning model may include a trained classification head to classify the defects. For example, the deep learning model ma be a ResNet18 model with a linear layer at the end that acts as a classification head.

In some embodiments, computing system 104 may interact with a database 120. Database 120 may store information relevant to the inspection process. In some embodiments, database 120 may store the golden template for each patterned specimen design and the identified distinct regions for each golden template, among other data.

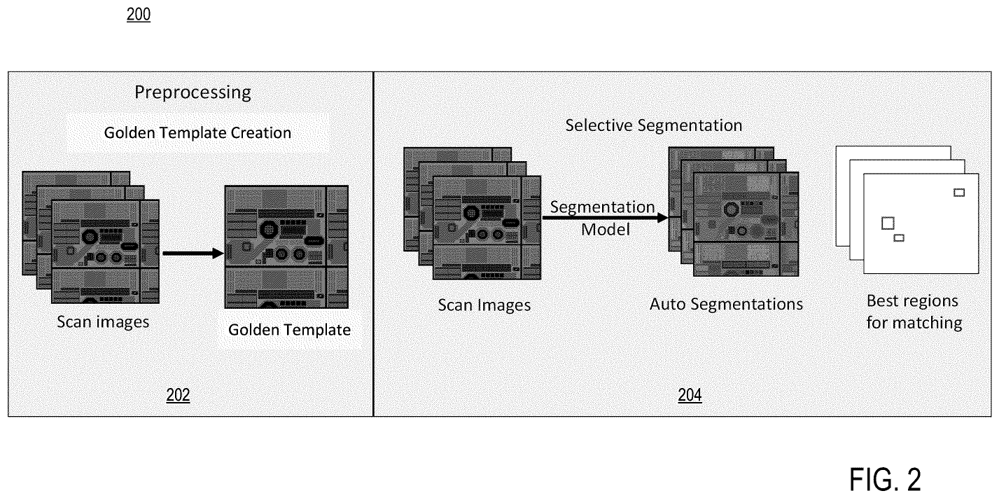

FIG. 2 is a block diagram illustrating a workflow 200 for pre-processing images for golden template creation and identification of best regions in a patterned specimen design for alignment, according to example embodiments.

As shown, workflow 200 may include two steps: a pre-processing step 202 and a selective segmentation step 204. During pre-processing step 202, golden template module 110 may create a golden template for a target patterned specimen design. For example, golden template module 110 may be configured to generate a golden template by receiving a plurality of scanned images of specimens fabricated according to the patterned specimen design. Golden template module 110 may generate a golden template for the patterned specimen design by aggregating each of the plurality of scanned images into a single image. The golden template will then act as the standard or template against which each new scanned image is compared for purposes of image alignment and defect detection.

During selective segmentation step 204, image alignment system 112 may analyze the plurality of scanned images to determine one or more regions for template matching. In some embodiments, the plurality of scanned images may be different than the plurality of scanned images used for generating the golden template. For example, golden template module 110 may analyze more images than that analyzed by image alignment system 112 during selective segmentation step 204. In some embodiments, the number of scanned images analyzed for selective segmentation step 204 may be a user defined parameter. In some embodiments, image alignment system 112 may deploy machine learning model 118 to identify one or more regions for template matching. Machine learning model 118 may be representative of a semantic segmentation model trained to generate a plurality of segmentation masks to determine those regions across the plurality of images that are considered the top or best regions for matching. In some embodiments, the top or best regions for matching may be those regions that are present across each of the plurality of images. In some embodiments, machine learning model 118 may employ an intersection over union analysis to identify those regions that are present across each of the plurality of images.

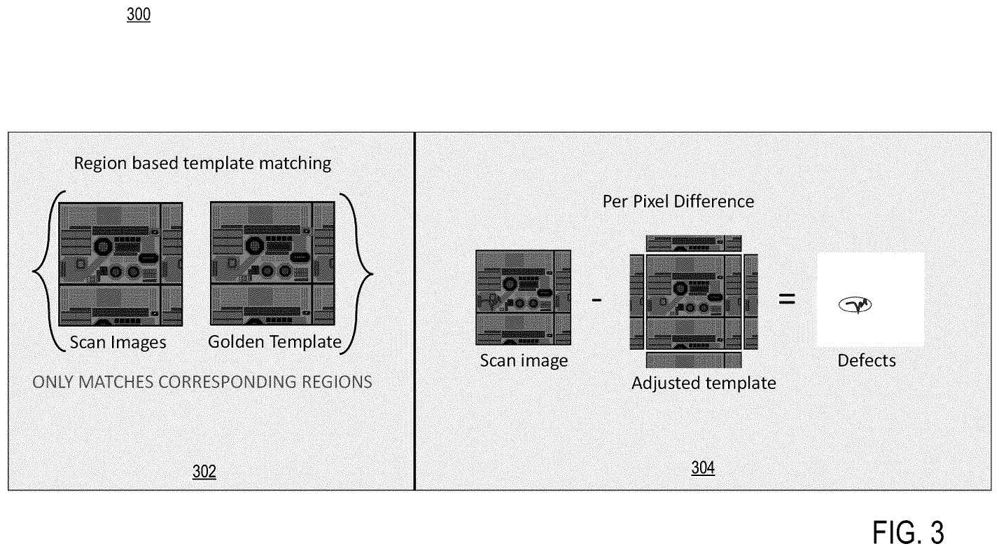

FIG. 3 is a block diagram illustrating a workflow 300 for detecting defects on a specimen, according to example embodiments.

As shown, workflow 300 may include two steps: an alignment step 302 and a defect detection step 304. During alignment step 302, image alignment system 112 may receive a scanned image of a specimen under manufacture from inspection system 102. Image alignment system 112 may align an orientation of the golden template with an orientation of the scanned image. Image alignment system 112 may align the orientation of the golden template with the orientation of the scanned by matching the one or more regions identified by machine learning model 118 or operator across the scanned image and the golden template. Thus, rather than perform a pixel-by-pixel analysis across the entirety of the image, image alignment system 112 may only need to perform a pixel-by-pixel comparison in the identified regions of interest, thus significantly reducing the computational complexity of the alignment process.

During defect detection step 304, defect detection module 114 may analyze the scanned image to detect defects or artifacts present thereon. In some embodiments, defect detection module 114 may identify defects or artifacts by comparing the scanned image to the aligned golden template. For example, defect detection module 114 may subtract the aligned golden template from the scanned image. Such subtraction process may eliminate or cancel out the regions of the aligned golden template that match the scanned image, leaving, as the remainder, differences between the aligned golden template and the scanned image. These differences may be referred to as defects or artifacts.

Although not shown, in some embodiments, workflow 300 may include a defect classification step. During the defect classification step, defect classification module 116 may analyze the identified defects or artifacts and classify them accordingly.

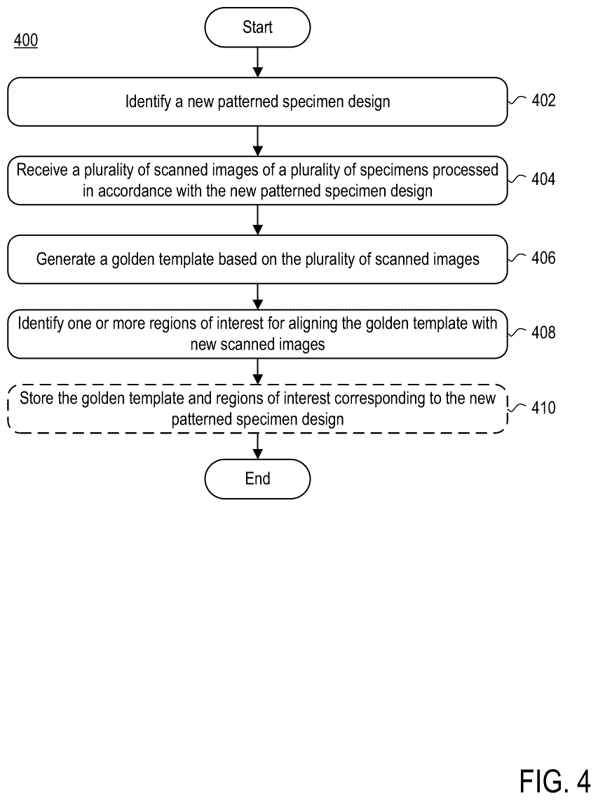

FIG. 4 is a flow diagram illustrating a method 400 of creating a golden template and identifying one or more regions in a patterned specimen design for alignment, according to example embodiments. Method 400 may begin at step 402.

At step 402, computing system 104 may identify a new patterned specimen design. For example, an operator may interact with computing system 104, instructing computing system 104 to create a new patterned specimen design file for analysis. In some embodiments, computing system 104 may create a new patterned specimen design file in database 120 for subsequent retrieval.

At step 404, computing system 104 may receive a plurality of scanned images of a plurality of specimens processed in accordance with the new patterned specimen design. For example, computing system 104 may receive a plurality scanned images of the plurality of specimens from inspection system 102.

At step 406, computing system 104 may generate a golden template based on the plurality of scanned images. For example, golden template module 110 may create a golden tie or template by aggregating each of the plurality of scanned images into a single coherent image. The resulting golden tie or template may then be used by downstream modules (e.g., image alignment system 112 and/or defect detection module 114) for image alignment and/or defect detection.

At step 408, computing system 104 may identify one or more regions of interest for aligning the golden template with a new scanned image. In some embodiments, image alignment system 112 may analyze the plurality of scanned images to determine one or more regions for template matching. For example, image alignment system 112 may deploy machine learning model 118 to identify one or more regions for template matching. Machine learning model 118 may be representative of a semantic segmentation model trained to generate a plurality of segmentation masks to determine those regions across the plurality of images that are considered the top or best regions for matching. In some embodiments, the top or best regions for matching may be those regions that are present across each of the plurality of images. In some embodiments, machine learning model 118 may employ an intersection over union analysis to identify those regions that are present across each of the plurality of images.

In some embodiments, rather than employ machine learning model 118 to identify the one or more regions for template matching, computing system 104 may instead receive the one or more regions of interest from an operator with knowledge of the patterned specimen design.

In some embodiments, method 400 may include step 410. At step 410, computing system 104 may store the golden template and regions of interest in database 120. In this matter, computing system 104 may retrieve the golden template and regions of interest information from database 120 when additional specimens are created in accordance with the patterned specimen design.

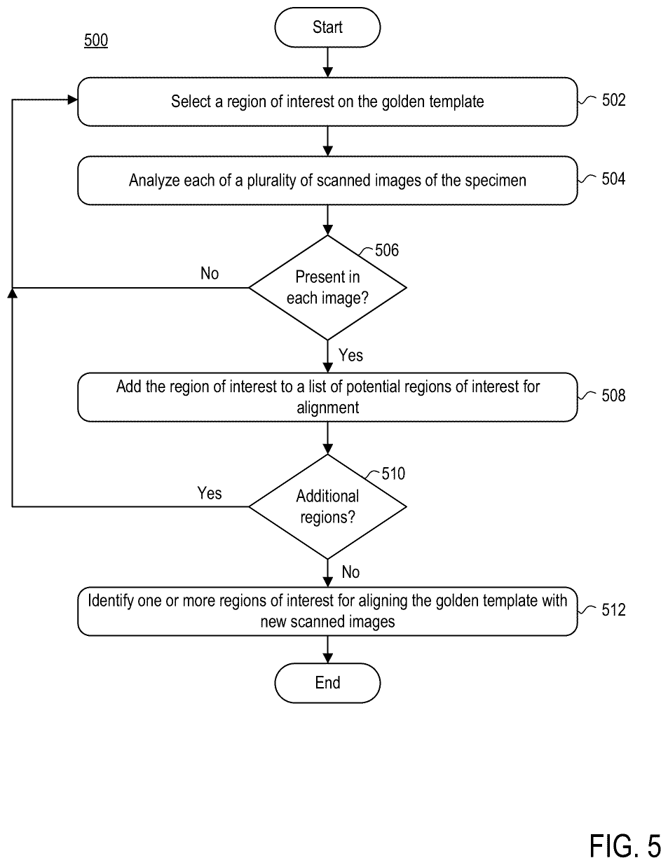

FIG. 5 is a flow diagram illustrating a method 500 of identifying one or more regions of interest for template matching, according to example embodiments. In some embodiments, method 500 may represent a more detailed version of step 408, discussed above in conjunction with FIG. 4, such as when machine learning model 118 is deployed to identify the one or more regions of interest. Method 500 may begin at step 502.

At step 502, computing system 104 may select a first region of interest on the golden template. In some embodiments, machine learning model 118 may select a first region of interest at random. In some embodiments, the bounds on the region of interest may be dependent on the type of machine learning model being used. For example, some machine learning models have a lower bound of 32 pixels in size. More generally, machine learning model 118 may consider all segmentations to start and then selectively filter through the segmentations across the plurality of scanned images.

At step 504, computing system 104 may analyze each of a plurality of scanned images of the specimen. For example, machine learning model 118 may use one or more segmentation masks to determine whether the selected region of interest is present across each of the plurality of images.

At step 506, computing system 104 may determine whether the region of interest is present across each of the plurality of images. In some embodiments, machine learning model 118 may employ an intersection of union analysis to determine whether the region of interest is present across each of the plurality of images. If, at step 506, machine learning model 118 determines that the region of interest is not present across each of the plurality of images (i.e., there is at least one scanned image that does not include the region of interest), then method 500 may revert to step 502 and computing system 104 may select a new region of interest for analysis.

If, however, at step 506, machine learning model 118 determines that the region of interest is present across each of the plurality of images, then method 500 may continue to step 508. At step 508, computing system 104 may add the region of interest to a list of potential regions of interest for alignment.

At step 510, computing system 104 may determine whether there are any additional regions of interest to analyze. If, at step 510, computing system 104 determines that there are additional regions of interest to analyze, then method 500 may revert to step 502, and computing system 104 may select a next region of interest to analyze. If, however, at step 510, computing system 104 determines that there are no additional regions of interest to analyze, then method 500 may proceed to step 512.

At step 512, computing system 104 may identify a subset of regions of interest for alignment. For example, machine learning model 118 or image alignment system 112 may select the top most distinctive regions of interest based on the list of regions of interest. In some embodiments, the top most distinctive regions of interest may be those regions of interest that have the highest intersection over union scores.

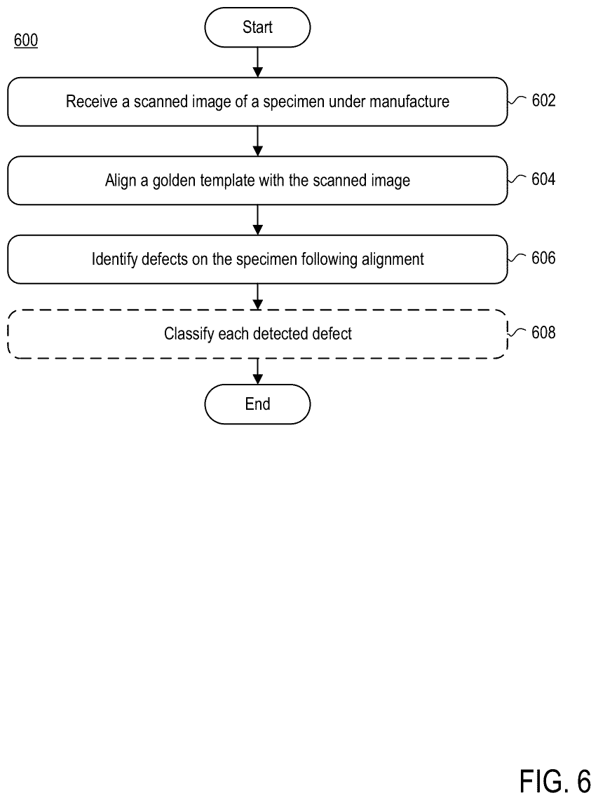

FIG. 6 is a flow diagram illustrating a method 600 of analyzing an image of a specimen for artifacts, according to example embodiments. Method 600 may begin at step 602.

At step 602, computing system 104 may receive a scanned image of a specimen under manufacture. In some embodiments, the specimen under manufacture may undergo a fabrication process in accordance with a pre-generated patterned specimen design.

At step 604, computing system 104 may align a golden template corresponding to the pre-generated patterned specimen design with the scanned image. For example, image alignment system 112 may align an orientation of the golden template with an orientation of the scanned image. Image alignment system 112 may align the orientation of the golden template with the orientation of the scanned by matching the one or more regions identified by machine learning model 118 or operator across the scanned image and the golden template. Thus, rather than perform a pixel-by-pixel analysis across the entirety of the image, image alignment system 112 may only need to perform a pixel-by-pixel comparison in the identified regions of interest, thus significantly reducing the computational complexity of the alignment process.

At step 606, computing system 104 may identify defects on the specimen following alignment of the golden template with the image of the specimen. For example, defect detection module 114 may analyze the scanned image to detect defects or artifacts present thereon. In some embodiments, defect detection module 114 may identify defects or artifacts by comparing the scanned image to the aligned golden template. For example, defect detection module 114 may subtract the aligned golden template from the scanned image. Such subtraction process may eliminate or cancel out the regions of the aligned golden template that match the scanned image, leaving, as the remainder, differences between the aligned golden template and the scanned image.

In some embodiments, method 600 may include step 608. At step 608, computing system 104 may classify each detected defect. For example, defect classification module 116 may analyze the identified defects or artifacts and classify them accordingly.

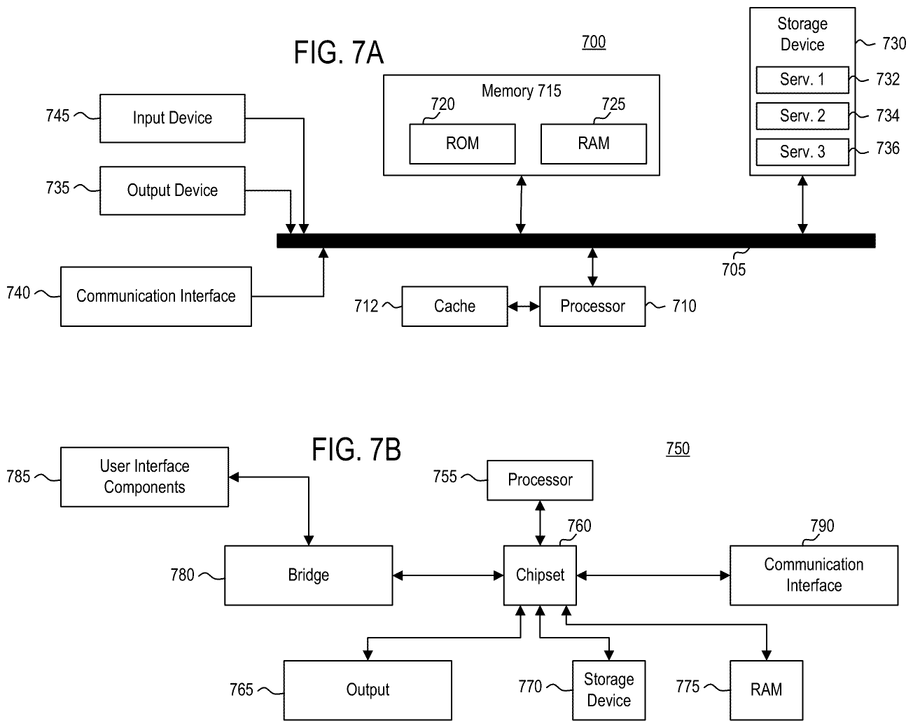

FIG. 7A illustrates a system bus architecture of computing system 700, according to example embodiments. System 700 may be representative of at least of computing system 104. One or more components of system 700 may be in electrical communication with each other using a bus 705. System 700 may include a processing unit (CPU or processor) 710 and a system bus 705 that couples various system components including the system memory 715, such as read only memory (ROM) 720 and random-access memory (RAM) 725, to processor 710.

System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech and so forth. An output device 735 may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735 (e.g., display), and so forth, to carry out the function.

FIG. 7B illustrates a computer system 750 having a chipset architecture that may represent at least computing system 104. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755.

In this example, chipset 760 outputs information to output 765, such as a display, and may read and write information to storage device 770, which may include magnetic media, and solid-state media, for example. Chipset 760 may also read data from and write data to storage device 775 (e.g., RAM). A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or storage device 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method of analyzing aligning a golden template with a scanned image of specimen under manufacture, comprising:
generating, by a computing system, a golden template for a patterned specimen design by forming a single coherent image from a first plurality of scanned images of a plurality of specimens manufactured according to the patterned specimen design;
identifying, by the computing system, a plurality of regions of interest in the patterned specimen design that is present across a second plurality of scanned images of the plurality of specimens manufactured according to the patterned specimen design;
receiving, by the computing system, a new scanned image of a new specimen manufactured in accordance with the patterned specimen design; and
aligning, by the computing system, the golden template with the new scanned image of the new specimen by performing a pixel-by-pixel analysis in the plurality of regions of interest only.

2. The method of claim 1, further comprising:
following the aligning, detecting, by the computing system, artifacts on the new specimen by comparing the new specimen with the golden template.

3. The method of claim 2, wherein comparing the new specimen with the golden template comprises:
subtracting first regions on the golden template from second regions on the new specimen.

4. The method of claim 1, wherein identifying, by the computing system, the plurality of regions of interest in the patterned specimen design that is present across the second plurality of scanned images of the plurality of specimens manufactured according to the patterned specimen design comprises:
receiving the plurality of regions of interest from an operator that has defined the plurality of regions of interest.

5. The method of claim 1, wherein identifying, by the computing system, the plurality of regions of interest in the patterned specimen design that is present across the second plurality of scanned images of the plurality of specimens manufactured according to the patterned specimen design comprises:
selecting, by the computing system, a first candidate region of interest; and
analyzing, by the computing system, each of the second plurality of scanned images to determine whether the first candidate region of interest is present in each of the second plurality of scanned images.

6. The method of claim 5, further comprising:
responsive to determining that the first candidate region of interest is present in each of the second plurality of scanned images, selecting, by the computing system, the first candidate region of interest as one of the plurality of regions of interest.

7. The method of claim 5, further comprising:
responsive to determining that the first candidate region of interest is not present in at least one of the second plurality of scanned images:
selecting, by the computing system, a second candidate region of interest, and
analyzing, by the computing system, each of the second plurality of scanned images to determine whether the second candidate region of interest is present in each of the second plurality of scanned images.

8. A non-transitory computer readable medium comprising one or more sequences of instructions, which, when executed by a processor, causes a computing system to perform operations comprising:
generating, by the computing system, a golden template for a patterned specimen design by forming a single coherent image from a plurality of scanned images of a plurality of specimens manufactured according to the patterned specimen design;
identifying, by the computing system, a plurality of regions of interest in the patterned specimen design that is present across a second plurality of scanned images of the plurality of specimens manufactured according to the patterned specimen design;
receiving, by the computing system, a new scanned image of a new specimen manufactured in accordance with the patterned specimen design; and
aligning, by the computing system, the golden template with the new scanned image of the new specimen by performing a pixel-by-pixel analysis in the plurality of regions of interest only.

9. The non-transitory computer readable medium of claim 8, further comprising:
following the aligning, detecting, by the computing system, artifacts on the new specimen by comparing the new specimen with the golden template.

10. The non-transitory computer readable medium of claim 9, wherein comparing the new specimen with the golden template comprises:
subtracting first regions on the golden template from second regions on the new specimen.

11. The non-transitory computer readable medium of claim 8, wherein identifying, by the computing system, the plurality of regions of interest in the patterned specimen design that is present across the second plurality of scanned images of the plurality of specimens manufactured according to the patterned specimen design comprises:
receiving the plurality of regions of interest from an operator that has defined the plurality of regions of interest.

12. The non-transitory computer readable medium of claim 8, wherein identifying, by the computing system, the plurality of regions of interest in the patterned specimen design that is present across the second plurality of scanned images of the plurality of specimens manufactured according to the patterned specimen design comprises:
selecting, by the computing system, a first candidate region of interest; and
analyzing, by the computing system, each of the second plurality of scanned images to determine whether the first candidate region of interest is present in each of the second plurality of scanned images.

13. The non-transitory computer readable medium of claim 12, further comprising:
responsive to determining that the first candidate region of interest is present in each of the second plurality of scanned images, selecting, by the computing system, the first candidate region of interest as one of the plurality of regions of interest.

14. The non-transitory computer readable medium of claim 12, further comprising:
responsive to determining that the first candidate region of interest is not present in at least one of the second plurality of scanned images:
selecting, by the computing system, a second candidate region of interest, and
analyzing, by the computing system, each of the second plurality of scanned images to determine whether the second candidate region of interest is present in each of the second plurality of scanned images.

15. A system, comprising:
a processor; and
a memory having programming instructions stored thereon, which, when executed by the processor, causes the system to perform operations comprising:
generating a golden template for a patterned specimen design by forming a single coherent image from a plurality of scanned images of a plurality of specimens manufactured according to the patterned specimen design;
identifying a plurality of regions of interest in the patterned specimen design that is present across a second plurality of scanned images of the plurality of specimens manufactured according to the patterned specimen design;
receiving a new scanned image of a new specimen manufactured in accordance with the patterned specimen design; and
aligning the golden template with the new scanned image of the new specimen by performing a pixel-by-pixel analysis in the plurality of regions of interest only.

16. The system of claim 15, wherein the operations further comprise:
following the aligning, detecting artifacts on the new specimen by comparing the new specimen with the golden template.

17. The system of claim 15, wherein identifying the plurality of regions of interest in the patterned specimen design that is present across the second plurality of scanned images of the plurality of specimens manufactured according to the patterned specimen design comprises:
receiving the plurality of regions of interest from an operator that has defined the plurality of regions of interest.

18. The system of claim 15, wherein identifying the plurality of regions of interest in the patterned specimen design that is present across the second plurality of scanned images of the plurality of specimens manufactured according to the patterned specimen design comprises:
selecting a first candidate region of interest; and
analyzing each of the second plurality of scanned images to determine whether the first candidate region of interest is present in each of the second plurality of scanned images.

19. The system of claim 18, further comprising:
responsive to determining that the first candidate region of interest is present in each of the second plurality of scanned images, selecting the first candidate region of interest as one of the plurality of regions of interest.

20. The system of claim 18, further comprising:
responsive to determining that the first candidate region of interest is not present in at least one of the second plurality of scanned images:
selecting a second candidate region of interest, and
analyzing each of the second plurality of scanned images to determine whether the second candidate region of interest is present in each of the second plurality of scanned images.
